(19) United States
(12) Patent Application Publication
(10) Pub. No.: US 2012/0159820 A1
(43) Pub. Date: Jun. 28, 2012

(54) Directional Advertising Sign Frame/Lightbox

(76) Inventor: Greg Alexander Van Saanen, San Diego, CA (US)

(21) Appl. No.: 12/979,988

(22) Filed: Dec. 28, 2010

(51) Int. Cl. G09F 13/18; G09F 7/04; G09F 15/00; G09F 21/04; G09F 13/12; G09F 21/02

(52) U.S. Cl. 40/546

(57) ABSTRACT

A sign having indicia that forms visual communication matter for use in a frame that has a light source for illuminating the indicia and an arrow removably attached to a side of the frame for directing a customer to a store. Bright colored sheets of translucent plastic are located on the front and back of the arrow and lights are located between the front and back translucent sheets of plastic to illuminated the arrow. A sheet of clear transparent plastic is attached to the frame in front of the sign, low energy lights are located around the front edge of the frame and a source of DC power is coupled to energize the lights located within the frame between the front and back of the bright colored translucent sheets of plastic of the arrow and the lights located around the front edge of the frame.

### BACKGROUND OF THE INVENTION

1. Field of the Invention

The present invention relates to an ultra-light, hand-held illuminated frame/lightbox for inter-changing signage having indicia that forms visual communication matter for use in a frame that has a light source for illuminating the indicia and may have an arrow removably attached to a side of the frame for directing people to a store, club, wedding or any other commercial or non-commercial facility or event, or simply making signage of any type and size (on vehicles, human directionals or anywhere else) visible to the public. A bright colored sheet of translucent plastic is located on the front of the arrow and lights are located behind the translucent sheets of plastic to illuminate the sign and arrow. Low energy lights may be located around the front edge of the frame and a source of DC power (as well as an option for an AC connection) is coupled to energize the lights located within the frame behind the bright colored translucent sheets of plastic of the signage and the arrow, and the lights located around the front edge of the frame and along the inside edge that illuminate the inserted sign.

2. Background of the Invention

Directional advertising signs utilize the current “human directional” concept which is increasingly being used world-wide by businesses and realtors due to its proven efficacy in local-based advertising. Currently, individuals are hired by local businesses to stand on the sidewalk/street-corner with arrow-shaped signs to direct automobile drivers and pedestrians attention to a business with their arrow-shaped signs. But currently this type of advertising is limited to daylight hours only due to visibility.

The invention here disclosed is a fully-customizable light weight illuminated sign for displaying industry-standard advertising. A frame is adapted to receive any commonly used standard-size plastic sign such as coroplast, plexiglass or Lexan which can be interchanged with other signs and is illuminated brightly at night from within a frame with AC power or DC power for several hours at a time, whether the sign is hand-held, free standing or wall mounted.

The light weight customizable sign here disclosed is a valuable service/product to a business during rush hour periods and particularly during the winter months when all sign carrying “human directionals” are ordered to quit for the day due to insufficient lighting.

This invention has the potential to open up a whole new market in directional advertising that is currently not being fully utilized for after-dark advertising services or equipment rental/lease/sales, as well as providing an affordable and viable business opportunity for the general public and further expanding an existing multi-billion dollar industry.

On safety, the sign utilizes outdoor-safe lighting and uses a safe low voltage, low wattage source of electrical power which is fuse protected and has additional electronic protection in place to prevent internal or external battery pack from over-charging or other possible hazard. On driver and pedestrian safety, the sign remains stationary while being hand-held and does not pose a risk to passer-bys, and the ultra-bright daylight-visible lighting automatically reduces in brightness as outside lighting grows dimmer, to avoid adversely affecting driver safety.

The sign here disclosed is safer and less distractive to drivers which has been a recently debated issue among the public, prompting city officials to try to ban acrobatic sidewalk “sign-spinners” in some areas of the U.S. not only because they are distracting entertainment for drivers, but they pose potential hazards for the drivers and pedestrians from possible accidents or injury due to a sign slipping from a persons hands or being carried off by the wind and ending up on a drivers' windshield or in a child's or pedestrian's face.

During the winter months it gets dark earlier, which cuts down even further on the amount of rush-hour time a sign-spinner can take advantage of before it becomes too dark to read the sign. The lighted sign here disclosed is more noticeable in daylight by utilizing daylight-visible flashing lights and, with its auto-dimming/brightening feature, can take advantage of the dark evening hours without being too bright for driver safety.

Each sign is completely mobile and may include an optional AC power source for longer/permanent use.

Shops with special sales have no way to visibly advertise a sale after sunset when everyone is getting off from work, particularly during the winter months when it gets dark early, other than by putting notices in front of their storefront, which is normally not effective if their shop is in a mall or complex.

A few of the advantages of the light weight internally illuminated sign here disclosed are as follows:
Far less liability-risk than hiring acrobatic sign spinners.
The sign here disclosed is easy to read during the night and day because it remains stationary while the lights animate the sign to attract attention.
Unlike “Sign spinners” which cannot always be read while they are being flipped and twirled, the sign here disclosed can always be read.

A need exists for a sign which can be used by businesses for their own use, by a wholesale who will sell to sign shops who will then resell as an accessory package with their current selection of signs where no custom work is needed, and for home business as independent contractors and sub-contractors.

### SUMMARY OF THE INVENTION

In an exemplary embodiment of the present invention, there is disclosed a sign having indicia that forms visual communication matter, said sign being for use in a sign frame that has a light source for illuminating the indicia, the sign frame comprising:
an arrow removably attached to either side of the sign frame for directing a perspective customer to a store that is providing the visual communication on the sign;
a bright colored sheet of translucent plastic located on the front of the arrow;
lights located the bright colored translucent sheet of plastic to provide a brightly illuminated arrow;
a sheet of clear transparent plastic attached to the frame and located in front of the sign;
low energy lights located around the front edge of the frame;
a source of DC power coupled to energize the lights located within the frame behind the bright colored translucent sheets of plastic of the arrow and the low energy lights located around the front edge of the frame and lighting along the inside edge of the frame positioned in front of where the inserted signage sits; and
a sheet of opaque backing material attached to the back of the frame and located behind the sign which serves to reflect light toward the arrow to help illuminate it and do the same for any semi-translucent inserted signage such as white acrylic or Lexan signs.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of a light weight self illuminated directional sign which may have a front panel which maybe mounted on a wall or a front and rear panel pivotally connected at their top edge with a hinge to form an A frame which can be set up in front of a store or at the curb in front of a store or which may include shoulder straps to allow the signs to be carried on the front and back of a person as he walks around a designated area. All of these situations may include the use of the arrow attachment if desired. In an embodiment one of the panels can be mounted on a wall and in another a much smaller panel magnetically attaches to a vehicle door to illuminate vehicle-door magnet advertisements for small businesses;

FIG. 2 is a view of the rear of the sign of FIG. 1;

FIG. 3 is a sectional view along the line 3-3 of FIG. 2; and

FIG. 4 is a view of a slide out panel 38 for FIG. 3 for back lighting function.

### DESCRIPTION OF THE PREFERRED EMBODIMENT

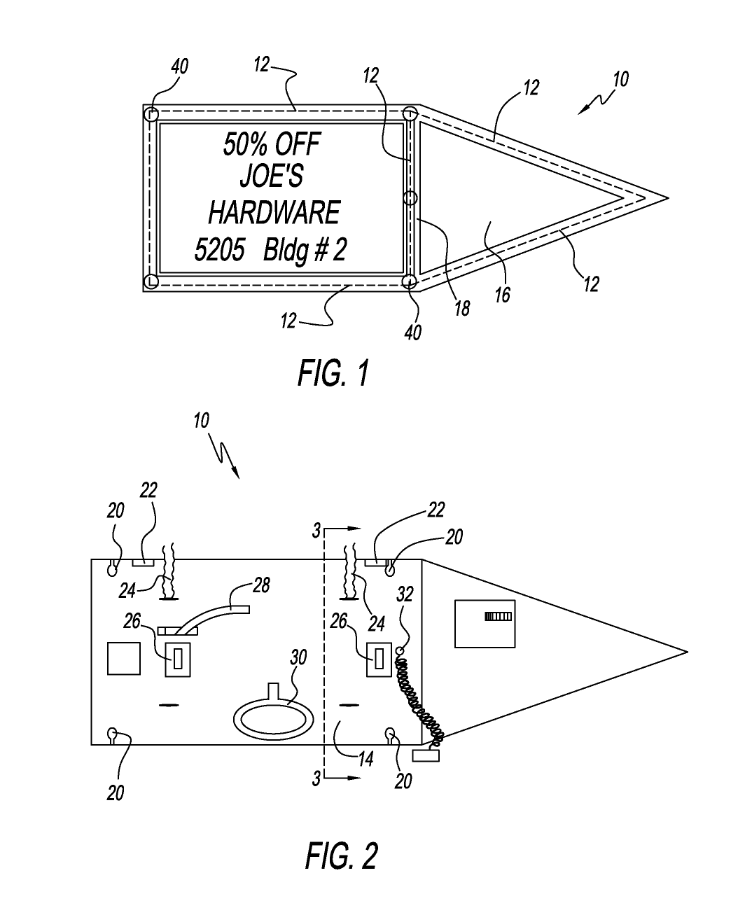

Referring to FIG. 1, there is shown a front view of a light weight self illuminated directional sign 10 which may be mounted on a wall or a front and rear panel pivotally connected at their top edge with a hinge to form an A frame which can be set up in front of a store or at the curb in front of a store or which may include shoulder straps to allow the signs to be placed on the front and/or back of a person as he stands stationary or walks around a designated area. There are also handles built into the backside for hired sign holders to hold and control sign as needed, with or without additional support from the shoulder straps and waist belt. In an embodiment, ultra-lightweight versions of this device that have NO BACKING, only a frame where a 2-SIDED sign can be inserted and viewed by pedestrians and drivers from either side at night. In this application the arrow would also be lit from both sides. THESE frames are THIN (each of 4 sides of these frames are no more than 2 or 3 inches wide×1 or 2 inches thick), are NOT BULKY, and come in the same variety

The illuminated sign may consists of very light weight aluminum and/or pre-molded plastic channels 12 and at least one hollow plastic/vinyl sheet of opaque backing material 14 (see FIG. 2) that is very easy to handle by a person for long periods or to be safely hung on a wall. The sign frame may have a dimension of between 12 inches by 12 inches, up to 2 ft×5 ft all the way up to 3 ft by 5 ft, and larger for custom applications. Optionally, removably attached to a side of the sign is a triangular arrow 16 formed with light weight aluminum or plastic channels 12 and having a translucent bright colored sheet of plastic such as red on its front surface. The triangular arrow may be attached to either side edge of the directional sign with slide hooks or latches and may include lights located between the front and rear transparent colored sheets of plastic where the lights, which are located within the triangular arrow, may be located around the inner perimeter of the triangle and may be energized by a battery which may be located either within or outside the device.

In an embodiment the lights in the triangular arrow may be connected to electrical contacts which are located on the base 18 of the triangular arrow and receive electrical energy from electrical contacts on either side of the sign which is connected to the power supply located within the sign.

The arrow on the sign is provided to direct a perspective customer to the store which is advertising or other commercial or non-commercial display or direction.

To provide a uniform brightness to the arrow 16, a sheet of light diffusing plastic may be located behind the transparent red acrylic top sheet of material and above the lights, and the triangle-shaped arrow can be detached from the sign to allow the sign to be used alone, either indoor or outdoors when the arrow is not needed. The user simply uncouples the triangular arrow from the sign by, for example, opening latches. The latches may have covers that flip over where the arrow and frame connect to hide unsightly holes or latches which may show when the arrow is not attached to the sign.

The arrow may be connected to the sign with a single power connection and slide-lock latches at the top and bottom of the frame. This will provide a professional-looking, presentable pre-molded rectangular frame which can be used in front of a store, used indoors or outdoors by clubs, as temporary or permanent menu boards for restaurants or mobile “lunch trucks”, or any other event where a lighted sign is desired and the arrow is unnecessary.

The internally illuminated directional sign here disclosed may be a single panel which can be removably attached to a wall, a sign having front and rear panels which are pivotally connected together to form a free standing A frame which may be placed on the side walk in front of a store, or a “sandwich” type of sign which consists of a front and rear sign panel located on the front and back of a person who walks along a defined path.

Referring to FIG. 2, there is shown a view of the rear of the sign of FIG. 1 which includes, in addition to electrical contacts, various members which enable the directional sign to be removably attached to a wall, to be removably attached to another directional sign to form a free standing A frame which can be placed on the side walk in front of a store, or which can be used as a “sandwich” type of sign.

Located on the back of the sign proximate each corner are openings and/or hooks 20 which can be used to hang the sign on a wall. Located at an edge of the sign are hinge connecting members 22 which can be connected to a hinge connecting means on a second sign to provide a free standing A frame type of sign which can be placed on the side walk in front of a store.

In an embodiment, two signs can be connected together with shoulder straps to provide a sandwich type of sign which can be placed on the front and back of a person as he either stands in front of a store or walks along a defined route. In this embodiment two shoulder straps 24, one for each shoulder, are attached to a front and rear sign and one or two handles 26 may be attached to each sign for the person carrying the signs to hold. If desired a strap 28 may be attached to the two handles on each sign or a waist strap 30 may be attached to each sign. Also located on the back of each sign are contacts 32 which are provided for connected to a battery (not shown) which may be removably attached to the back of the sign or which can be carried by the person carrying the sandwich type signs.

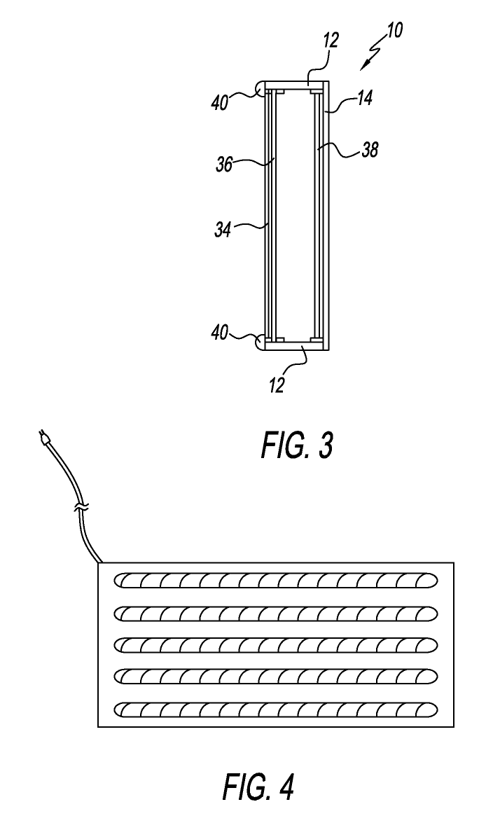

Referring to FIG. 3, there is shown a sectional view along the line 3-3 of FIG. 2. The internally illuminated directional sign frame has a thickness of between 3 and 4 inches formed with aluminum or plastic channels 12. Located on the front of the frame is a sheet of clear transparent plastic 34 where the back of the frame may have opaque backing material 14. One side of the frame has slots for inserting a slide out sign panel into the frame and a separate slot for inserting a panel with thin LED strips with reflective panel onto which the strips are attached (to reflect the light forward) and light-diffusing layer over the light panel to spread that light more evenly, see 38, FIG. 4.

The lights of the directional sign may consist of low-energy daylight-visible flashers 40 located around the front edge of the sign for enhanced daytime advertising, and the super-thin, super-bright, very low-energy, long-lasting super-efficient HB-LED bulbs located around the inside perimeter within the frame to light the inserted sign, and additional animated, controllable lights of same type (night-use only) all around the outer perimeter in front of the frame to attract viewer attention.

Wafer thin HB-LED light strips and small reflectors may be used to light the sign for night-time advertising. Even brighter HB-LED strips may be used in the sign for optionally backlighting the signs. These same strips may also be placed inside and along the outer edge of the red acrylic arrow and energized to provide a blinking racing red “arrow”. When combined with fully controllable white or multi-color racing lights or other light display patterns along the edge, a living sign is created that is both attention grabbing and visible in substantially all lighting conditions.

The intensity of the daylight visible emergency type LED flashers is determined by a small hidden light-sensor on the front of the frame, which will brighten/dim the flashers to remain safe for on coming drivers during dark nigh time hours while staying bright enough to see during daylight hours. These Lights are removably attached to the sign and may be interchanged with similar other lights of different color and intensity which are designed for various occasions such as weddings, Christmas, Halloween, corporate meeting, street-advertising for business, etc.

The type of flashing, which lights to use, color and intensity of the lights, etc., can be customized via a control panel located on the back of the sign. The control panel may have a key-lock to prevent unauthorized access and the number of customizable control options which are available will depend on the light accessories that are present. Since all HB-LED bulbs are DC-power based, there is no need for an internal inverter when running off a battery, although there may be an AC adapter cable with a built-in AC-to-DC power inverter that comes with the sign for plug-in indoor-outdoor use. The entire unit can be turned around or the arrow can be repositioned to “point” left or right.

The sign may have detachable and re-positionable shoulder and waist straps for safety, especially in high wind areas to help reduce strain and provide comfort when being carried as a sandwich sign.

In an embodiment of the invention a backlighting LED panel may be provided which can slide out and be left out to eliminate unnecessary weight when not needed, or interchanged between 12 volt LED bulbs or 24 volt SUPER-BRIGHT LED bulbs for very bright backlighting.

An embodiment of the invention can be an adjustable or non-adjustable cordless (self-contained with no external battery pack) sign flipper model. Both the Adjustable and non-adjustable slimline models will not provide backlighting for clear acrylic/lexan signs, and may not have a lit blinking arrow, but will instead be geared toward providing a more lightweight, less bulky option for people who don't need anything other than a light weight handheld sign that lights up at night, especially for signspinners/flippers' arrow-shaped signs.

The variable-adjustable slimline sign may have multiple sections that slide apart by pressing in buttons to unlock and extend the frame to accommodate various sized frames and also provide a means for inserting that sign into the frame. Inserting signs into the non-adjustable slimline model could have the same “door” that opens on one side to allow the signage to be slid into the frame. The adjustable sign may have the “door” for inserting signs or instead just be inserted front-ways by enlarging the frame with the slide-locks and extending them, inserting the bottom of the sign into the bottom tracks first then adjusting the frame to fit snuggly around the sign. After the frame is locked in place, the sign can be freely used without shoulder straps since the slimline frame adds only minimal weight to the sign.

The cordless embodiment may be designed primarily for the acrobatic sign flippers, especially for the standard arrow-shaped signs. These signs will be slimline models due to the necessity of light weight and will be properly balanced for efficient flipping and twirling and may be available in adjustable frames. The built-in battery pack and the frame itself may be internally and externally reinforced and padded with shock-absorbing material to prevent damage from ground impact if dropped while flipping in the air. In an embodiment this sign may have 2 ports: 1 for plugging in AC adapter cord for recharging the built-in battery, and another port for inserting an external battery pack in case the built-in battery starts getting too low on power.

In an embodiment of the invention a tall narrow compartment located behind the sign may be provided which includes a “kickstand” that extends out to support the sign so it can be easily placed anywhere on the ground, on a table or on any surface for customer/passerby viewing. The kickstand also provides support for the sign to remain upright to protect the rear from minor damage.

In an embodiment of the invention detachable replaceable low-profile screw-in anti-skid pads may be placed on top and bottom edges of the frame to protect the frame from being scratched when being set down on either end.

In an embodiment of the invention a removable vertical support bar is attached to the back of the sign to prevent the sign from bending inward and breaking due to high winds. The bar can be easily removed when a backlighting feature is used to prevent a crossbar shadow from appearing from behind.

enhance its presence.

In an embodiment of the invention, the sign may be used for small or large gatherings such as conferences, seminars and workshops, weddings, parties, business meetings, etc.

The sign here disclosed will find utility in the mobile advertising arena in at least two ways, which will further expand this invention as an economical, practical business use for:
(1) Hardware that clamps the larger standard street-advertising indoor/outdoor frames to the sides/tailgate of a truck so that up to 3 of the frames may be clamped onto a truck for instant day/night mobile advertising to both drivers and pedestrians, either to advertise their own business or for marketers to provide mobile advertising services to businesses without having to invest in the more costly mobile-advertisement trailers/trucks currently on the market, and.
(2) As an economical option for small businesses/startups to night-advertise while on the road which can come in much smaller adjustable versions for vehicles. The weatherproof mini frames will light up existing advertising vehicles by being magnetically attached to the outside of a vehicles door, tailgate, etc. A thin, long power cord which goes from the unit to a cigarette lighter through a window of the vehicle may be used to supply needed power. All 4 sides of the mini frames will be able to be lengthened or shortened according to dimensions needed via slide-and-lock attachment means by pressing and then releasing a spring loaded button to lock in position. No-scratch padding may be used to prevent scratching the paint on the vehicle during attaching/removal, and easy quick removal/placement means allows a driver to remove the sign while the driver is away from the vehicle to prevent theft.

The sign disclosed may include the following:
Additional internal battery packs (custom-designed to fit in the frame's battery compartments).
Extended use larger batteries together with a weather-resist, insulated case & spiral cord.
Waist pack/holder for external battery pack connection.
External battery charger for virtually non-stop use.
Street+Sidewalk display combination pack, one lightweight display in front facing the street and the other lightweight display in back facing pedestrians.
Super-bright flashing beacons for daylight use that utilize the same sensor which is built into the frame to auto dim at night for driver safety
Additional lights/flashers, such as multi-color small LED night time flashers, which can be plugged into the same units for greater attention-grabbing effectiveness and more lighting/flasher customizability.
Options for various light configurations, colors and display patterns for sign and frame lights and flashers which includes the lighting for the inserted sign itself and backlight for the arrow portion of frame. Controls may be provided for altering lighting colors, type of light-animation such as slow gradual fades, still, various patterns, direction of light movement, chasing lights circling frame or “directing” lights moving from one end of the frame to the other, which is especially useful where the arrow is used to further enhance directional effect, and general brightness (useful to dim for indoor or up-close viewing so to not be too bright/distracting for people to read).
Mounting hardware for wall-hanging (easy removal for on-the-go use).
Colored light-rods for user to utilize in addition to signage to further+enhance directional effect
Clear Plexiglas or Lexan protective sheet to slide in with and located in front of the sign to protect the sign from damage, dirt, high wind, flying debris, and vandalism.
Additional pre-designed “skin” options for the entire frame (front, side and back) that can be permanently customized with solid colors, glossy or flat/matte, patterns, professional wood-grain look, psychedelic/wild, themes, etc.
In addition, they can also purchase extra snap-on face-plates or “Chameleon Covers” (like how cell phone covers snap on and off) with these same pre-printed or custom-job options which are designed to cover just the sides and front for when unit is hung on the wall. This provides the option to have a permanent look for use anywhere, while keeping the option to change the look as needed for events or holidays.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A sign having indicia that forms visual communication matter, said sign being for use in a sign frame that has a light source for illuminating the indicia, the sign frame comprising:
an arrow which is removably attached to either side of the sign frame for directing a perspective customer to a store that is providing the visual communication on the sign;
a bright colored sheet of translucent plastic located on the front of the arrow;
lights located to illuminate the bright colored translucent sheet of plastic to provide a brightly illuminated arrow;
a sheet of clear transparent plastic attached to the frame and located in front of the sign;
low energy lights located around the front edge of the frame;
a source of DC power coupled to energize the lights located within the frame behind the bright colored translucent sheets of plastic of the arrow and the low energy lights located around the front edge of the frame and lighting along the inside edge of the frame positioned in front of where the inserted signage sits; and
a sheet of opaque backing material attached to the back of the frame and located behind the sign which serves to reflect light toward the arrow to help; illuminate it and do the same for any semi-translucent inserted signage such as white acrylic or Lexan signs.

2. The sign of claim 1 wherein the lights around the front edge of the frame flash.

3. The sign of claim 2 wherein the flashing lights around the front edge of the frame race around the frame.

4. The sign of claim 3 wherein a light sensor is located on the front of the frame and is coupled to brighten/dim the flashing lights.

5. The sign of claim 4 wherein a control panel is coupled to the light sensor to control the type of flashing that is displayed by the flashing lights.

6. The sign of claim 1 wherein the arrow has a triangular shape.

7. The sign of claim 6 wherein the lights which are located within the arrow are located around the inner perimeter of the arrow.

8. The sign of claim 7 wherein the arrow is removably attached to the side edge of the frame with slide hooks or latches.

9. The sign of claim 8 wherein openings or hooks are located on the back of the frame to allow the sign to be hung on a wall.

10. The sign of claim 8 wherein hinge connecting members are attached to an edge of the frame for receiving hinge connecting members on a second sign having indicia that forms visual communication matter which is similar to the first sign to provide a free standing A frame type of sign which can be placed on a sidewalk in front of a store.

11. The sign of claim 8 wherein shoulder straps are attached to the frame of the sign and to a second sign having indicia that forms visual communication matter which is similar to the first sign to provide a sandwich type of sign which can be placed on the front and back of a person as he either stands in front of a store or walks along a defined route.

12. The sign of claim 9 wherein the frame has a thickness of between 3 and 4 inches.

13. The sign of claim 8 wherein a kickstand is pivotally connected to the back of the sign that extends out to support the sign so it can be placed on the ground, or on a table, or on a surface for viewing by a person passing the sign.

14. The sign of claim 8 wherein magnets are located on the back of the frame to allow the sign to be attached to the side of a vehicle.

15. The sign of claim 8 wherein the source of power is a battery.

16. The sign of claim 15 wherein the battery is removably attached to the back of the sign.

17. The sign of claim 11 wherein the source of power is a battery removably attached to the back of one of the signs.

18. The sign of claim 11 wherein the source of power is a battery that is carried by the person carrying the sign.
